(19) United States
(12) Patent Application Publication
(10) Pub. No.: US 2026/0333075 A1
(43) Pub. Date: Oct. 22, 2026

(54) INTERFERENCE IDENTIFICATION AND MITIGATION SYSTEM FOR WIFI NETWORKS

(71) Applicant: Charter Communications Operating, LLC, St. Louis, MO (US)

(72) Inventors: Michael MULH, Centennial, CO (US); Taren MCCULLOUGH, Plymouth, MN (US)

(21) Appl. No.: 19/181,925

(22) Filed: Apr. 17, 2025

(51) Int. Cl. H04W 24/02; H04W 84/12

(52) U.S. Cl. CPC H04W 24/02; H04W 84/12

(57) ABSTRACT

Various embodiments include a method of identifying and mitigating non-WiFi sources of interference in a WiFi network performed by a WiFi access point. The method may include detecting a performance issue in the WiFi network due to non-WiFi interference, performing an active scan to identify characteristics of the detected non-WiFi source of interference, comparing the identified characteristics to a database of known non-WiFi interferers to determine whether a source of the non-WiFi interference is recognized, determining a mitigation action based on a result of the comparison, and executing the determined mitigation action to address the detected non-WiFi source of interference.

### FIELD OF INVENTION

The present disclosure relates to interference detection and mitigation in wireless networks, and more particularly to a system for identifying and responding to non-WiFi interference sources in WiFi networks using an intelligent database of known non-WiFi interferers.

### BACKGROUND

Wireless communication networks have become ubiquitous in modern society, enabling connectivity for a wide range of devices and applications. WiFi technology, based on the IEEE 802.11 standards, is one of the most widely adopted wireless networking protocols, providing high-speed data transmission in homes, offices, and public spaces. As the number of WiFi-enabled devices continues to grow, efficient spectrum utilization and interference management have become increasingly important considerations in network design and operation.

The 2.4 GHz and 5 GHz frequency bands used by WiFi networks are shared with various other wireless technologies and devices, including Bluetooth, ZigBee, cordless phones, and non-communication devices like microwave ovens. The coexistence of multiple radio frequency (RF) emitters in these unlicensed bands may lead to signal interference, potentially impacting the performance and reliability of WiFi networks. While methods exist for addressing interference from other WiFi sources, there is currently no widely adopted or standardized approach for identifying and mitigating interference from non-WiFi (non-802.11) sources. This gap in interference management capabilities presents an ongoing challenge in the field of wireless communications, as the inability to effectively recognize and respond to non-WiFi interference may result in suboptimal network performance and user experience.

### SUMMARY

This summary is provided to introduce concepts of various aspects in a simplified form that are further described below in the detailed description. This summary is not intended to identify key or essential features of the claimed subject matter, nor is it intended to be used as an aid in determining the scope of the claims.

In various aspects, a method of identifying and mitigating non-WiFi source of interference in a WiFi network performed by a WiFi access point may include detecting a performance issue in the WiFi network due to non-WiFi interference, performing an active scan to identify characteristics of the detected non-WiFi source of interference, comparing the identified characteristics of the detected non-WiFi source of interference to a database of known non-WiFi interferers t to determine whether a source of the non-WiFi interference is recognized, determining a mitigation action based on a result of the comparison, and executing the determined mitigation action to address the detected non-WiFi interference.

In some aspects, detecting the performance issue may include monitoring at least one of packet loss, latency, or jitter in the WiFi network.

In some aspects, the database of known non-WiFi interferers may be maintained in a remote server or the cloud.

In some aspects, the database of known non-WiFi interferers may include information on fundamental frequencies, harmonics, and durations of known non-WiFi interferers.

In some aspects, the database may further include safe interference reduction thresholds for different types of interferers.

In some aspects, determining the mitigation action may include selecting between changing operating channels and reducing bandwidth based on characteristics of the identified non-WiFi source of interference.

In some aspects, the method may include logging the identified characteristics of non-WiFi interference that is not recognized in a performance issue database, and transmitting the logged characteristics to a remote server for analysis.

Further aspects may include a computing device having a processing system configured with processor-executable instructions to perform operations corresponding to any of the methods summarized above. Further aspects may include a non-transitory processor-readable storage medium having stored thereon processor-executable instructions configured to cause a processing system to perform operations corresponding to any of the methods summarized above. Further aspects may include a computing device having various means for performing functions corresponding to any of the method operations summarized above.

### BRIEF DESCRIPTION OF THE FIGURES

The accompanying drawings, which are incorporated herein and constitute part of this specification, illustrate exemplary embodiments of the claims, and, together with the general description given and the detailed description, serve to explain the features herein.

FIG. 1A is a block diagram of a system for monitoring and responding to WiFi interference according to various embodiments.

FIGS. 2A-2D illustrate a process flow diagram of a method for monitoring and responding to WiFi interference according to various embodiments.

FIG. 3 is a table illustrating examples of different frequencies and amplitudes of non-WiFi interferers that may be encountered in WiFi networks.

FIG. 4A is a table listing elements of databases and logs that may be used by a processing system of a WiFi access point in performing the operations according to various embodiments.

FIG. 4B is an example of a performance issue database that may be maintained by a processing system of a WiFi access point in performing the operations according to various embodiments.

FIG. 4C is an example of a database of known non-WiFi interferers that may be used by a processing system of a WiFi access point in performing the operations according to various embodiments.

FIG. 4D is an example of an input voltage monitoring database that may be used by a processing system of a WiFi access point in performing the operations according to various embodiments.

FIG. 5A is a graph showing an example of non-WiFi interference with some WiFi channels.

FIG. 5B is a graph showing another example of non-WiFi interference with some WiFi channels.

FIG. 6 is a process flow diagram of a method for identifying WiFi interference sources according to various embodiments.

FIG. 7 is a process flow diagram of a method implemented by a server for collecting information regarding new and changed non-WiFi interference from various WiFi access points and updating a database of known non-WiFi interferers that may be deployed via over-the-air updates according to some embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments include a system and method for identifying and mitigating non-WiFi sources of interference in WiFi networks using an intelligent database of known non-WiFi interferers. The system employs a WiFi access point configured to detect performance issues, actively scan for interference characteristics, log characteristics of non-WiFi interference in a performance issue database, compare detected interference to a database of known non-WiFi interferers, and execute targeted mitigation actions to address the interference.

This approach enables WiFi networks to effectively manage previously unaddressable non-802.11 interference sources, improving network performance and reliability. The system also incorporates a learning component, logging unrecognized interference patterns and transmitting them to a remote server for analysis and potential database updates, allowing the interference mitigation capabilities to evolve over time.

The terms “computing system” and “computing device” are used herein to refer to (but not limited to) any one or all of servers, workstations, desktop computers, laptop computers, and other similar computing systems that include a memory for storing documents and neural network computational data, and a programmable processing system that may be configured to provide the functionality of various embodiments. The processing system may include neural network processors, such as graphical processing units, and neural network memory modules for running specialized large language model artificial intelligence (LLM AI) modules trained or fine-tuned according to various embodiments.

The term “processing system” is used herein to refer to one or more processors, including multi-core processors, graphics processing units (GPU), neural network processing units (NPU), microprocessor units (MPU), arithmetic logic units (ALU), memory systems, etc., that are organized and configured to perform computing functions of various embodiments as described herein.

The terms “WiFi interference” and “802.11 interference” are used herein to refer to interference from other WiFi transmitters operating in the same frequency bands. In contrast, “non-WiFi interference” and “non-802.11 interference” are used herein to refer to radio frequency interference from sources that do not use the WiFi protocol. Examples of non-WiFi interference sources include, but are not limited to, Bluetooth devices, cordless phones, microwave ovens, baby monitors, wireless security cameras, certain types of LED lights, electrical shorts, emissions from starting electric motors, and other household appliances that emit radio frequency signals. In some cases, industrial equipment, medical devices, or even intentional signal jammers may also contribute to non-WiFi interference in WiFi networks.

Related systems for detecting and mitigating interference in WiFi networks are primarily focused on addressing interference from other WiFi sources operating in the same frequency bands. However, these related systems often fall short in identifying and responding to non-WiFi interference sources, such as Bluetooth devices, cordless phones, microwave ovens, and other household appliances that emit radio frequency signals in the same spectrum. Consequently, persistent performance issues and degraded user experience may persist in WiFi networks affected by non-802.11 interference. Therefore, there is an unmet need for a WiFi access point system that can effectively detect, characterize, and mitigate non-WiFi interference sources while maintaining compatibility with existing WiFi infrastructure and protocols.

In some embodiments, a system 100 may include a WiFi access point 102 configured to perform interference identification and mitigation in WiFi networks. The WiFi access point 102 may include a processing system 104 coupled to electronic storage 108 and a WiFi transceiver 112. The electronic storage 108 may include machine readable instructions 106 that, when executed by the processing system 104, cause the processing system 104 to perform various operations related to interference detection and mitigation.

The electronic storage 108 of the WiFi access point 102 may include a performance issue database 109 and a known interferer database 110. The performance issue database 109 may store information about detected performance issues in the WiFi network, while the known interferer database 110 may contain information about known non-WiFi interferers, including their characteristics and potential mitigation strategies.

The WiFi access point 102 may also include a WiFi antenna 114 connected to the WiFi transceiver 112 for transmitting and receiving WiFi signals. In some cases, the WiFi access point 102 may communicate with various devices in the WiFi network, such as a mobile device 116 and a laptop computer 118.

The machine readable instructions 106 may be organized into various software modules, each responsible for specific functions of the WiFi access point 102. These modules may include an access point functions module 120, an interference monitoring module 122, an interference database module 124, an interference response module 126, and a server interface module 128.

The access point (AP) functions module 120 may include instructions to cause the processing system 104 to perform operations including standard WiFi access point functions such as managing connections and routing data.

The non-WiFi interference monitoring and logging module 122 (also referred to as the interference monitoring module 122) may include instructions to cause the processing system 104 to perform operations including detecting performance issues in the WiFi network and monitoring input voltage to detect potential interference issues. In some embodiments, the WiFi access point 102 may include a voltage database storing information on expected input voltage ranges, which may be used by the interference monitoring module 122 to identify potential interference based on voltage fluctuations.

The interference database lookup module 124 (also referred to as interference database module 124) may include instructions to cause the processing system 104 to perform operations including managing and updating the known interferer database 110, as well as comparing detected interference characteristics to the database entries.

The non-WiFi interference response module 126 (also referred to as interference response module 126) may include instructions to cause the processing system 104 to perform operations including determining and executing appropriate mitigation actions based on the identified interference.

The server interface for log uploading and OTA database update module 128 (also referred to as server interface module 128) may include instructions to cause the processing system 104 to perform operations including communicating with remote servers to share interference data and receive updates to the known interferer database 110.

In some embodiments, the WiFi access point 102 may be connected to an access network 130, which may in turn be connected to a wide area network 132, such as the internet. This connectivity may allow the WiFi access point 102 to communicate with remote servers for data sharing and database updates.

The WiFi access point 102 may include a non-transitory processor-readable medium with stored processor-executable instructions. These instructions, when executed by the processing system 104, may cause the WiFi access point 102 to perform various operations related to interference detection, characterization, and mitigation.

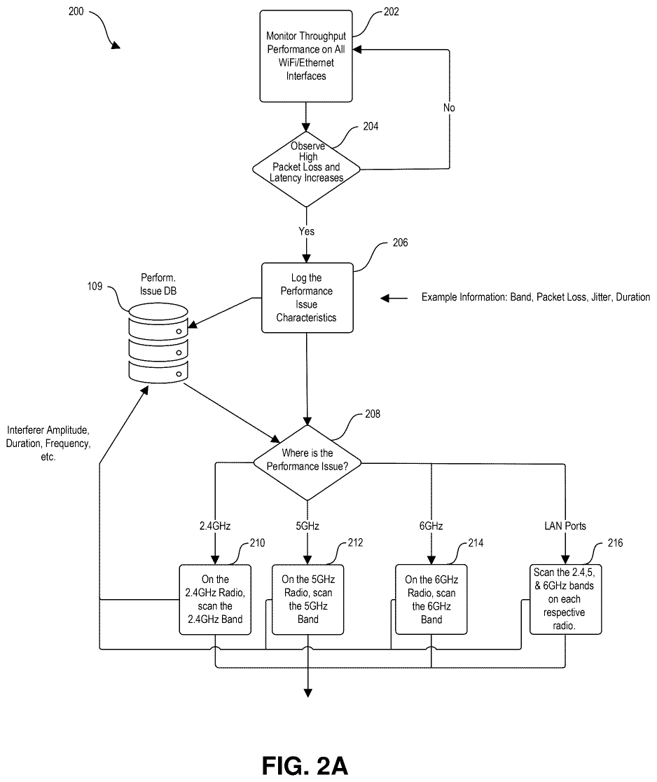

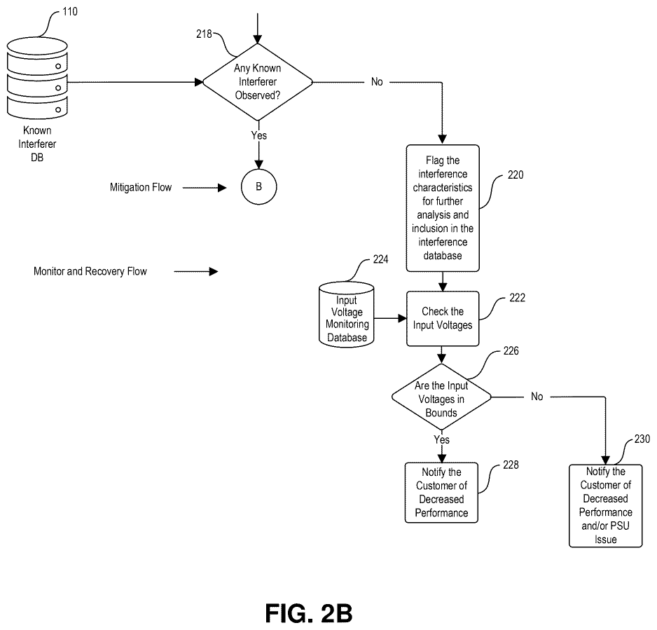

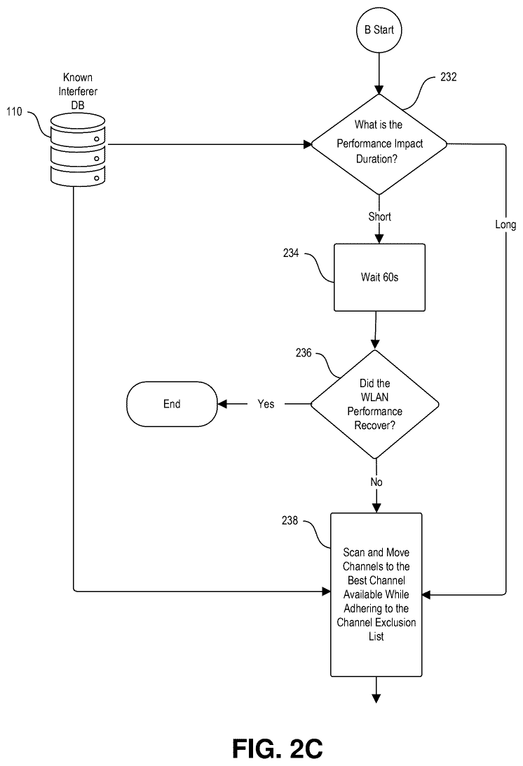

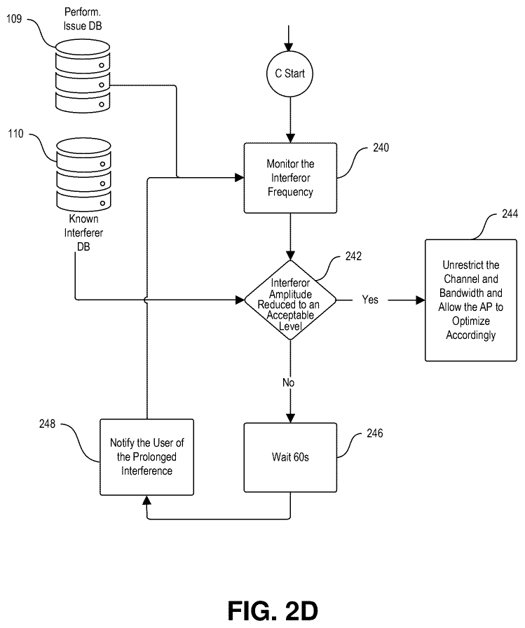

In some embodiments, the WiFi access point 102 may execute a method 200 for detecting and mitigating non-WiFi interference in a WiFi network. FIGS. 2A-2D illustrates operations of a method 200 that may be performed by the processing system 104 of the WiFi access point 102.

Referring to FIG. 2A, in operation 202, the processing system may execute the interference monitoring module 122 to detect a performance issue in the WiFi network due to non-WiFi interference. Performance issues may be detected by monitoring at least one of packet loss, latency, or jitter in the WiFi network.

In determination operation 204, in instances in which no performance issue is detected (i.e., determination 204=“No”), the processing system continue performing operations 202. In instances in which a performance issue is detected (i.e., determination 204=“Yes”), the processing system may log the performance issue in the performance issue database 109 in operation 206. The logged information may include details such as the impacted frequency band, packet loss rate, jitter, and duration of the detected performance issue.

In determination operation 208, if the performance issue persists, the processing system may execute instructions in the interference monitoring module 122 to identify the frequencies in which the interference is detected (e.g., determine where the performance issue exists) and initiate an active scan to identify characteristics of the detected non-WiFi source of interference. The active scan may be performed within the frequencies in which interference is detected (i.e., in frequencies in which the performance issue/interference is detected). For example, in instances in which the interference is detected in the 2.4 GHz channel, the processing system may perform a scan of the 2.4 GHz band in block 210. In instances in which the interference is detected in the 5 GHz channel, the processing system may perform a scan of the 5 GHz band in block 212. In instances in which the interference is detected in the 6 GHz channel, the processing system may perform a scan of the 6 GHz band in block 214. Further, in instances in which the interference is detected in the local area network (LAN) ports, the processing system may perform a scan of the 2.4, 5, and 6 GHz bands in block 216. The interference characteristics determined in any or each of the scans 210, 212, 214 and/or 216 may also be logged in the performance issue database 109.

Referring to FIG. 2B, in determination operation 218, the processing system may execute the interference database module 124 to compare the identified characteristics of the detected non-WiFi source of interference to the known interferer database 110. The known non-WiFi interferer database may be maintained in a remote server in the “cloud.” In some embodiments, a local copy of the known non-WiFi interferer database may also be stored in local memory of the WiFi access device, thus enabling comparisons to the database without delays associated with accessing a remotely stored or cloud-hosted database. As described herein, this comparison of determined characteristics to known non-WiFi interference characteristics may include comparing one or more of fundamental frequency, harmonics, duration, and impacted channels to recognize a known interferer based on similarities in one or more of these characteristics.

In instances in which the determination operation 218 results in a finding that there is not match of the detected interference to a known non-WiFi interferer (i.e., determination 218=“No” branch), the processing system may perform operations including flagging the interference characteristics for further analysis and inclusion in the interference database in block 220. The processing system may also check the input voltages in block 222, compare the input voltages to values in a voltage database 224, and determine in determination operation 226 whether there are any voltages in bounds (indicating the cause of interference is external) or whether there are any voltages are out of bounds, which may indicate voltage anomalies could be a cause of the interference.

In operation 228, in instances in which input voltages are in bounds (i.e., determination 226=“Yes”), the processing system may notify a user of the decreased performance caused by a detected but unrecognized interference. After this notification, the processing system may return to monitoring the WiFi network performance in block 202 and continue with operations in the method 200 as described herein.

In operation 230, in instances in which input voltages are out of bounds (i.e., determination 226=“No”, there are voltage anomalies), the processing system may execute the server interface module 128 to notify a user or a technician of the decreased performance caused by a power supply unit (PSU) issue. In this case, resolution of the detected interference may involve replacing the PSU or replacing the access device if the input voltage issue is due to fault or failure of the power management module within the device.

Returning to determination operation 218, in instances in which there is a match of the detected interference to a known non-WiFi interferer (i.e., determination 218=“Yes”), the processing system may perform operations including using information on the recognized source of non-WiFi interference obtained from the database of known non-WiFi interferers 110 to determine the likely duration of WiFi network performance impact caused by the interference in determination operation 232 illustrated in FIG. 2C. As described herein, this information may have been gathered by a remote server through crowd-sourcing and reflect when (e.g., time of day, day of week, etc.) and/or how long the recognized type of interference is typically observed. In embodiments in which a copy of the database of known non-WiFi interferers is stored in memory of the access point, the processing system can quickly assess whether the interference impact will be of a short or long duration.

Referring to FIG. 2C, if the duration information obtained from the database of known non-WiFi interferes 110 indicates that the interference is likely of a short duration (determination operation 232=“Short” branch), the processing system may wait for a predetermined duration in operation 234, such as 60 seconds. In some embodiments, the duration of the wait operation 234 may be based on the duration information obtained from the database of known non-WiFi interferes 110. In some embodiments, the duration of the wait operation 234 may be pre-programmed in the WiFi access device firmware, such as a duration predetermined to be an acceptable duration to wait before retesting the interference. In some embodiments, the duration of the wait operation 234 may be selected by the processing system based upon a type of application executing on a client device or nature of data being accessed or streamed to a client device.

After waiting in operation 234, the processing system may monitor the WiFi network performance to determine whether the interference has ended and performance of the network has recovered in determination operation 236. In instances in which the network performance has recovered (i.e., determination operation 236=“Yes”), the processing system may the processing system may return to monitoring the WiFi network performance in block 202 and continue with operations in the method 200 as described.

In instances in which the processing system determines that the network performance has not recovered from a short duration interference (i.e., determination operation 236=“No”) or if the duration information obtained from the database of known non-WiFi interferes 110 indicates that the interference is likely of a long duration (i.e., determination operation 232=“Long” branch), the processing system may perform operations to scan frequencies to identify channels not on a channel exclusion list with better or best WiFi communications, and move WiFi network communications to another channel accordingly in operation 238. Thus, in response to a recognized long-duration interference or a short-duration interference that is not ending within an expected or acceptable duration, the mitigation action taken by the WiFi access point may be to switch communications to a better or best channel.

Referring to FIG. 2D, after making such a channel change in operation 238, the processing system may perform operations 240 to continuously or periodically monitor interference signals in the previous channel to enable recognizing when the detected interference ends or declines in amplitude to acceptable levels. For example, the processing system may periodically tune a radio to the previous frequency and measure the amplitude of signals in frequencies where interference was detected in operations 206-216 using similar processes. In this operation 240, the processing system may recall information regarding the interference in the previous channel from the performance issue database 109. In this operation, the processing system may also use information characterizing the recognized source of interference stored in the known non-WiFi interferer database 110.

In determination operation 242, the processing system may determine whether the amplitude of the recognized non-WiFi interference in the previous channel has declined to or below an acceptable level. In this operation, the processing system may use information regarding amplitudes of the recognized source of interference that can be handled by WiFi access points using the encoding and error correction methods of the 802.11 WiFi protocol that may be stored in the known non-WiFi interferer database 110.

In instances in which the processing system determines that the recognized non-WiFi interference in the previous channel has reduced to or below an acceptable level (i.e., determination operation 242=“Yes”), the processing system may un-restrict the channel and bandwidth and allow the access point to use the channel in the processes of selecting best channels for supporting WiFi network communications in operation 244. Thereafter, the processing system may return to monitoring the WiFi network performance in block 202 and continue with operations in the method 200 as described.

In instances in which the processing system determines that the recognized non-WiFi interference in the previous channel remains above an acceptable level (i.e., determination operation 242=“No”), the processing system may wait a predetermined duration (e.g., 60 seconds) in operation 246, before notifying the user of the prolonged interference in operation 248 and then repeating operations 240-248 as described.

The embodiments process allows the WiFi access point 102 to effectively detect, characterize, and mitigate non-WiFi interference sources, while also learning from new interference patterns to improve future mitigation efforts.

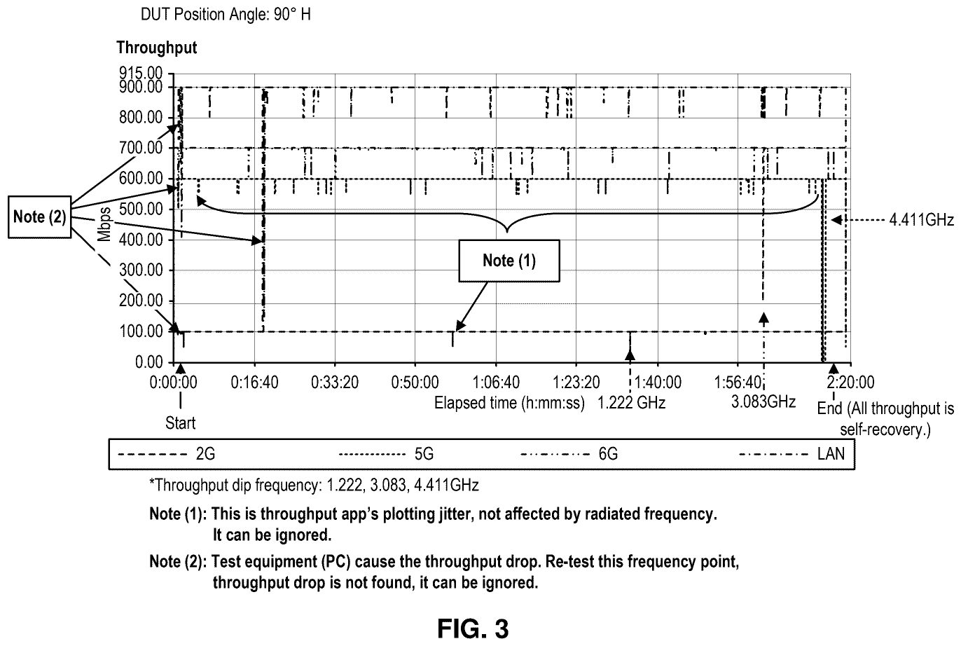

FIG. 3 illustrates examples of different frequencies and amplitudes of non-WiFi interferers that may be encountered in WiFi networks. The figure shows non-limiting examples of various interference patterns across different frequency bands.

In the 2.4 GHz band, the figure illustrates interference sources such as Bluetooth devices, which may produce short-duration, frequency-hopping signals across the band. Microwave ovens may be represented as a broadband interferer centered around 2.45 GHz with a relatively high amplitude.

The 5 GHz band may include interference from radar signals, which may appear as periodic, high-amplitude pulses at specific frequencies. Weather radar systems may be shown operating in the 5.6-5.65 GHz range, while airport surveillance radar may be depicted in the 5.25-5.35 GHz range.

In the newly available 6 GHz band, the figure illustrates potential interferers such as satellite uplinks or fixed wireless services. These may appear as narrowband, continuous signals at specific frequencies within the band.

Examples of time-varying interference patterns are shown, demonstrating how some non-WiFi interferers may have intermittent or periodic behavior. For instance, a cordless phone system may exhibit a series of short transmissions at varying frequencies within the 2.4 GHz or 5 GHz bands.

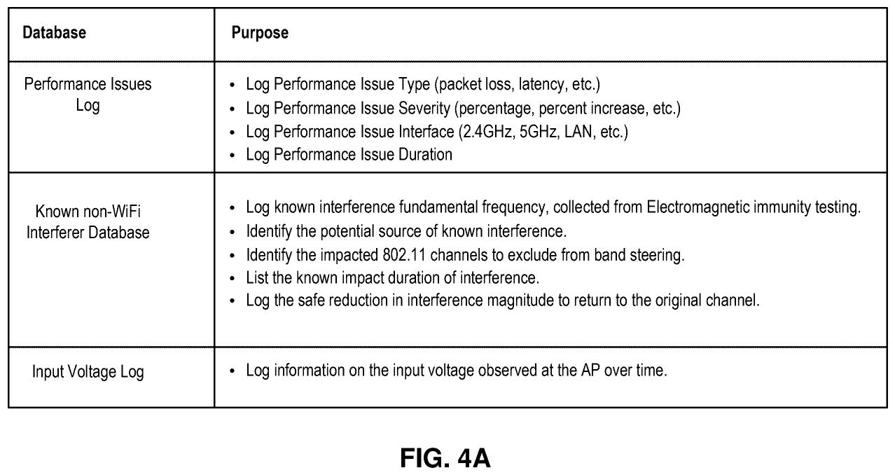

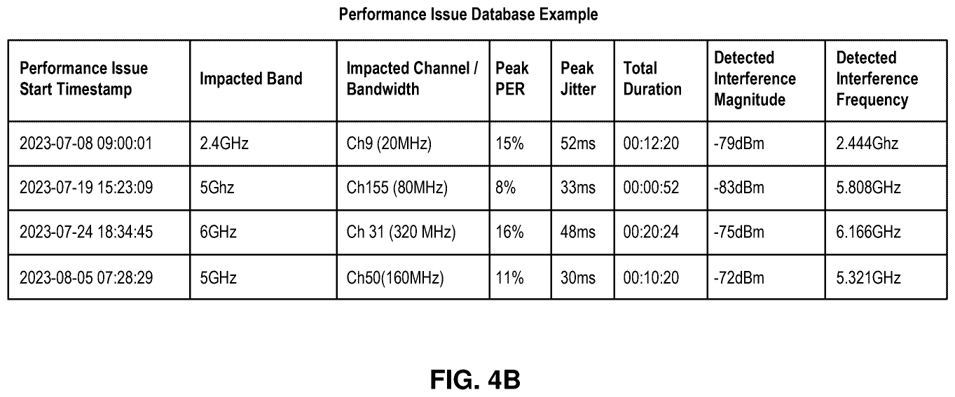

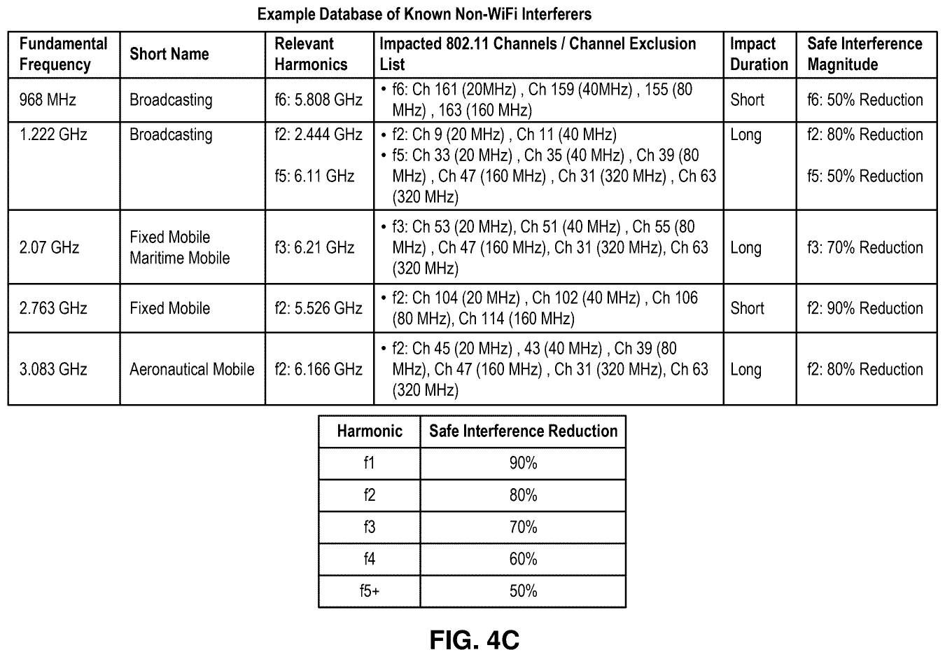

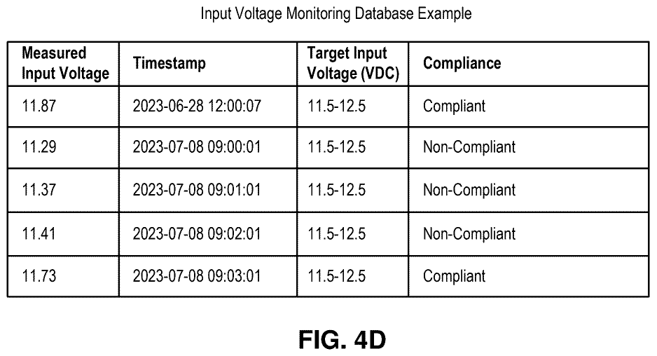

In some embodiments, the WiFi access point 102 may utilize various signal analysis tables that may be stored in the database of known non-WiFi interferers to identify and mitigate non-WiFi interference in WiFi networks. FIG. 4A provides an overview of the databases and logs used by the system 100 in various embodiments. As described herein, the WiFi access point 102 may include a performance issue database 109, a known interferer database 110, and a voltage database 224.

The performance issue database 109 may store information about detected performance issues in the WiFi network. FIG. 4B provides an example of entries in the performance issue database 109. In some cases, the performance issue database 109 may include fields such as a timestamp, impacted band, packet loss rate, jitter, and duration of the performance issue. This information may be used by the interference monitoring module 122 to detect and characterize potential interference events.

The known non-WiFi interferer database 110 may contain information about known non-WiFi interferers, including their characteristics and potential mitigation strategies. FIG. 4C illustrates an example of entries in the known interferer database 110. In some embodiments, the known interferer database 110 may include fields such as the interferer name, fundamental frequency, harmonics, duration, impacted channels, and safe interference reduction. This information may be used by the processing system executing the interference database module 124 to compare detected interference characteristics with known non-WiFi interferers and determine appropriate mitigation actions.

In some cases, the known interferer database 110 may include an interference reduction threshold f1, an interference magnitude threshold f2, a performance impact threshold f3, a signal degradation threshold f4, and a maximum interference threshold f5+. These thresholds may be used by the processing system executing the interference response module 126 to determine the severity of the interference and select appropriate mitigation actions.

In some embodiments, the WiFi access point 102 may wait for a configurable time period before taking mitigation actions for short-duration interference. This behavior may be based on information stored in the known interferer database 110, which may indicate whether an interferer typically has a short or long duration.

The known interferer database 110 may further include safe interference reduction thresholds for different types of interferers. These thresholds may be used by the interference response module 126 to determine instances in which the interference has been sufficiently mitigated.

In some embodiments, the WiFi access point 102 may generate an exclusion list of channels and bandwidths to avoid based on detected interference. This exclusion list may be derived from the information stored in the known interferer database 110, particularly the impacted channels field.

In some embodiments, the known interferer database 110 may be initially populated through lab testing of the WiFi access point 102. During the development process, the WiFi access point 102 may be subjected to various interference sources, and the resulting data may be used to populate the database.

The WiFi access point 102 may determine whether the interference is of short-duration or of long-duration based on the information stored in the known interferer database 110. This determination may influence the mitigation strategy chosen by the interference response module 126.

The known non-WiFi interferer database 110 may include information on safe interference reduction thresholds for different interferers. These thresholds may be used to determine when mitigation actions have successfully reduced the interference to an acceptable level.

The voltage database 224 may store information on expected input voltage ranges for the WiFi access point 102. FIG. 4D shows an example of entries in the voltage database 224. In some embodiments, the voltage database 224 may include fields such as the expected voltage range, measured voltage, and potential interference source. The interference monitoring module 122 may use this information to identify potential interference based on voltage fluctuations.

The WiFi access point 102 may check input voltage against expected ranges stored in the voltage database 224 to identify potential interference. This additional check may help distinguish between interference caused by external sources and issues related to power supply fluctuations.

In some embodiments, radio frequency (RF) energy from various sources and their harmonics may introduce noise to WiFi channels, potentially impacting WiFi communications. The Federal Communications Commission (FCC) has allocated specific frequency bands for unlicensed use, including the Unlicensed National Information Infrastructure (U-NII) bands. These U-NII bands encompass frequencies in the 5 GHz and 6 GHz ranges, which are commonly used for WiFi communications.

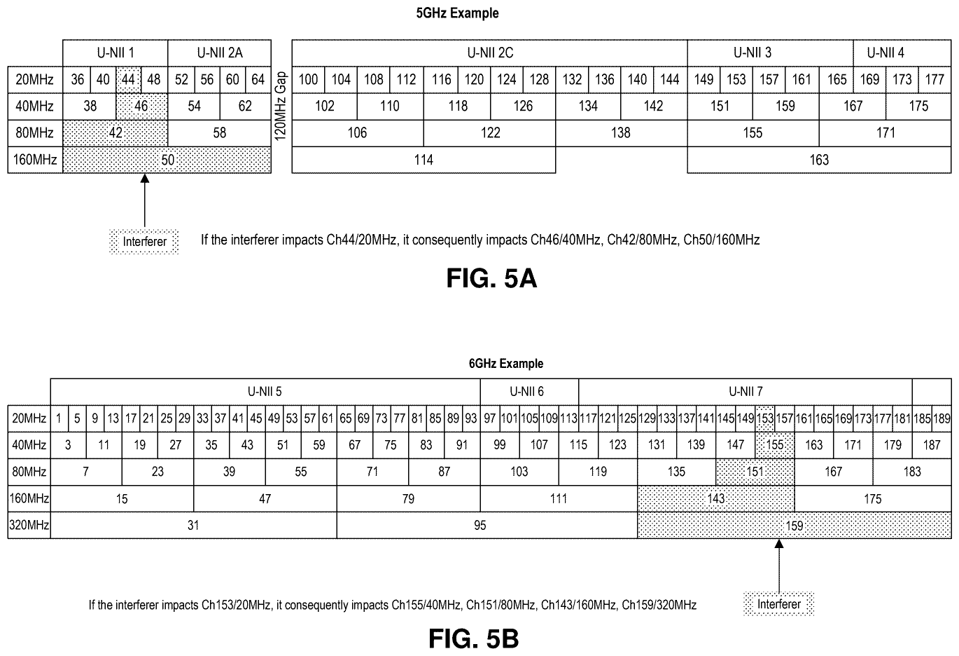

FIG. 5A illustrates an example of RF interference in WiFi channels. The figure shows a frequency spectrum with multiple U-NII bands, including U-NII-1, U-NII-2A, U-NII-2C, U-NII-3, and U-NII-4. Each of these bands may be used for different WiFi channels. FIG. 5A illustrates demonstrates how an example non-WiFi RF source may introduce interference across some bands. Specifically, FIG. 5A illustrates how a peak interference signal in the U-NII-1 band may be due to interference from a nearby Bluetooth device, while a broader peak in the U-NII-2C band may indicate interference from a microwave oven. The figure also shows how harmonics from lower frequency sources may impact higher frequency bands, such as a harmonic from a 2.4 GHz source appearing in the U-NII-3 band.

FIG. 5B provides another example of RF interference, focusing on the newly allocated 6 GHz band. This figure shows the U-NII-5, U-NII-6, U-NII-7, and U-NII-8 bands and illustrates how different types of non-WiFi RF sources may affect these bands. For example, a narrow peak in the U-NII-5 band may represent interference from a fixed wireless service, while a broader peak in the U-NII-7 band may indicate interference from a satellite uplink. FIG. 5B also demonstrates how the interference patterns may vary in amplitude and bandwidth across different frequency ranges, potentially affecting multiple WiFi channels simultaneously.

These examples highlight the complex nature of RF interference in WiFi networks and the importance of identifying and mitigating such interference to maintain acceptable network performance. The interference patterns shown in FIGS. 5A and. 5B may be used by WiFi access points to recognize and characterize non-WiFi interference sources, enabling more effective mitigation strategies.

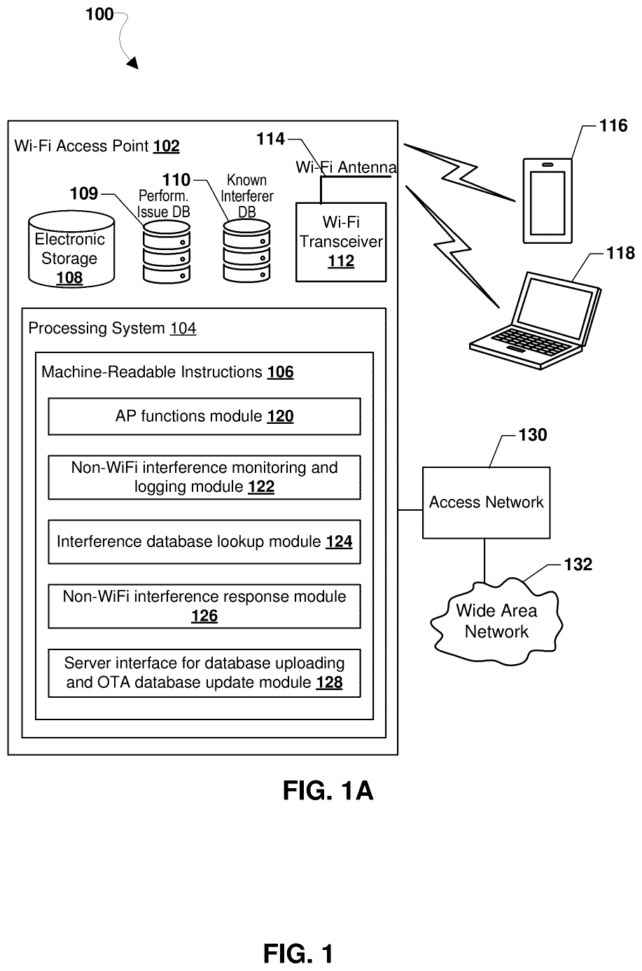

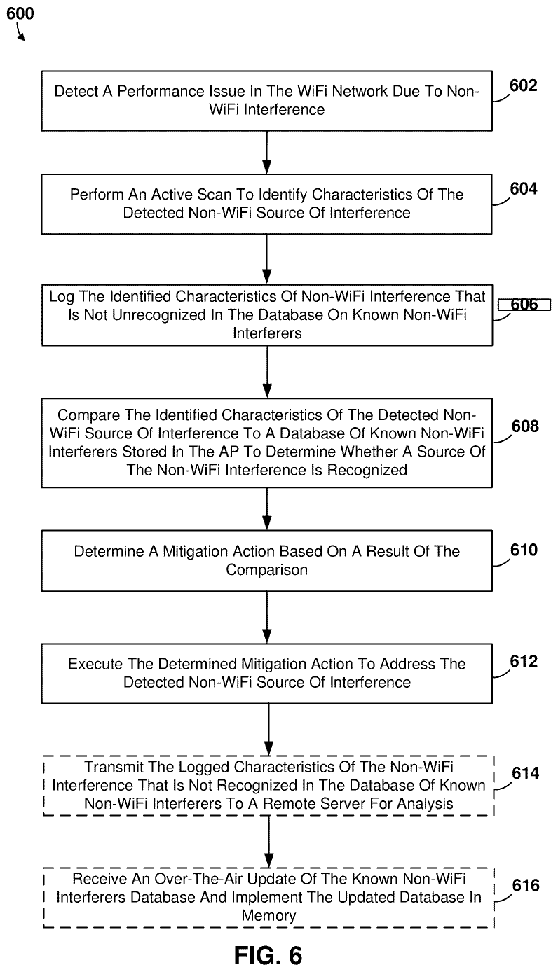

FIG. 6 is a process flow diagram illustrating a method 600 that may be performed by a WiFi access point 102 for identifying and classifying non-WiFi interference sources in a WiFi network. With reference to FIGS. 1-6, the method 400 may be performed in a processing system 104 on an access point implementing software modules as described with reference to FIG. 1. Means for performing the functions of the operations in the method 600 may include a processing system including one or more processors and other components described herein. Further, one or more processors of a processing system may be configured with software or firmware modules (e.g., AP Functions module 120, Interference Monitoring and logging module 122, Interference Database Lookup module 124, non-WiFi interference response module 126, and server interface module 128) to perform some or all of the operations of the method 600. To encompass the alternative configurations enabled in various embodiments, the hardware implementing any or all of the method 600 is referred to herein as a “processing system.”

In block 602, the processing system may execute operations in the interference monitoring module 122 to detect a performance issue in the WiFi network. The performance issue may be identified by monitoring network metrics such as packet loss, latency, or jitter. In some embodiments, the processing system may also monitor fundamental frequencies and harmonics of known (i.e., identified in the know) to recognize when signals are being received in those frequencies, thus indicating a performance issue occurring due to a known interference source.

In block 604, the processing system may execute operations in the interference monitoring module 122 may include instructions to cause the processing system 104 to perform operations including performing an active scan to collect signal characteristics. This active scan may involve measuring signal strength across various frequency channels when WiFi traffic is not detected, because the source of such signals will thus not be from WiFi devices (i.e., non-WiFi interference sources).

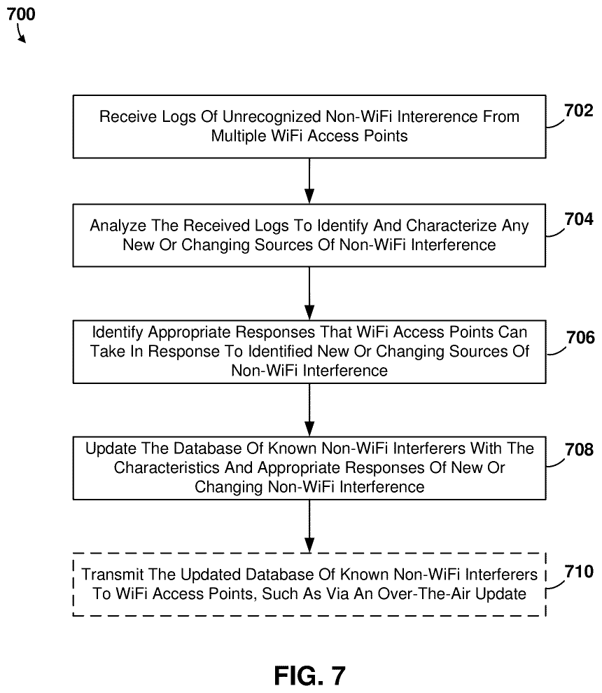

In some of embodiments as part of the operations in block 604, the processing system 104 may log the signal characteristics of the detected interference. This logging process may involve recording details such as the impacted frequency band, signal strength, duration of the interference, and any observed patterns or periodicities. The logged information may be stored in the performance issue database 109, which may include fields for timestamp, impacted band, packet loss rate, jitter, and duration of the performance issue. By maintaining a comprehensive log of interference characteristics, the WiFi access point 102 may build a more robust understanding of the non-WiFi interference sources present in its environment, which may be analyzed to improve future detection and mitigation efforts such as by a separate computing device as described below with reference to FIG. 7.

In optional block 606, the processing system may log the identified characteristics of the non-WiFi interference in a database for keeping track of interference events and characteristics. This logging operation may include recording details such as the detected packet loss, latency, jitter, frequency range, signal strength, duration, and impact on WiFi communications of the unrecognized interference.

In block 608, the processing system may execute operations in the interference database lookup module 124 to compare the detected signals to known interference patterns stored in the known non-WiFi interferer database 110 to determine whether a source of the non-WiFi Interference is recognized. The known non-WiFi interferer database may be maintained in a remote server in the “Cloud” and the operations in block 606 may include accessing the database in the cloud. In some embodiments, a local copy of the known non-WiFi interferer database may also be stored in local memory of the WiFi access device, thus enabling the processing system to perform the comparison operations in block 606 without delays associated with accessing a remotely stored or cloud-hosted database. Signal characteristics such as fundamental frequency, harmonics, duration, and impacted channels may be compared to corresponding entries in the known non-WiFi interferer database 110 to identify potential matches or similarities with previously documented interference sources. Signal characteristic of the detected non-WiFi interference stored in the performance issue database 109 may be utilized in this comparison process, allowing the system to cross-reference newly characterized interference signals with previously logged incidents.

In block 610, the processing system may execute the known non-WiFi interferer database module 124 to determine a mitigation that the WiFi access point can take based on the result of the comparison performed in block 608. If a match is identified in block 608, the processing system may obtain information from the known non-WiFi interferer database 110 regarding mitigating actions that can be taken when such interference is recognized.

In block 612, the processing system may execute the interference response module 126 to perform determined mitigation action(s) to address the detected non-WiFi interference. if the interference source matches a known interferer and the database of known non-WiFi interferers includes an appropriate mitigation action (as may be obtained as part of the operations in block 610), the processing system may implement such actions. In instances in which no match to a known non-WiFi interferer is determined in block 608, the processing system may perform a default action, such as avoiding channels in which the detected interference is detected. In some embodiments, in which the source of detected interference is not recognized, the WiFi access point 102 may notify a user of the access point or a network technician about the unidentified interference. This notification may be triggered if the interference persists beyond a predetermined threshold duration, alerting relevant parties to the potential need for manual intervention or further investigation.

In optional block 614, the processing system may transmit the logged characteristics of the non-WiFi interference that is not recognized in the database of known non-WiFi interferers to a remote server for further analysis. In some embodiments, such transmissions may be performed in response to a query received from the remote server. In some embodiments, such transmissions may be initiated by the WiFi access point, such as in a query-response exchange with the server, when a new interference is detected (e.g., when an unrecognized interference exceeds a predetermined threshold of interference with or disruption of WiFi communications on one or more channels). Transmissions of such logs to a remote server may enable crowdsourced identification of new interference sources.

In some embodiments, the database of known non-WiFi interferers may also be stored in local memory of the WiFi access device. In such embodiments, the processing system may perform operations in optional block 616 to receive an updated database of known non-WiFi interferers (e.g. 110) via an over-the-air update, and perform operations to store the updated database in memory of the WiFi access point for use in subsequent performances of the method 600.

In some cases, the method 600 may utilize various thresholds stored in the known non-WiFi interferer database 110 to recognize sources of interference in block 606 and determine appropriate mitigation actions in response to the detected interference in block 608. As illustrated in FIGS. 4A-4D, such thresholds may include the interference reduction threshold f1, the interference magnitude threshold f2, the performance impact threshold f3, the signal degradation threshold f4, and the maximum interference threshold f5+.

In some embodiments, the system 100 may execute a method 700 for analyzing and updating information about non-WiFi interference sources based on crowdsourced data from multiple WiFi access points. FIG. 7 illustrates a flowchart of the method 700 that may be performed by a processing system of a remote server connected to a wide area network (e.g., 132) that communicates with multiple access points.

In block 702, the server may perform operations including receiving logged interference characteristics from multiple WiFi access points. These logged characteristics may be transmitted by WiFi access points when they encounter unrecognized interference patterns.

In block 704, the server may perform operations including aggregating and analyzing the received interference data to identify and characterize any new or changing sources of non-WiFi interference. This analysis may involve identifying common patterns or characteristics across multiple reports from different WiFi access points. This may further include recognizing sources of non-WiFi interference that occur frequently or periodically. This analysis may also assess the potential impact that such new or changing sources of non-WiFi interference may have on WiFi communication channels, identify maximum levels or amplitudes of such interference that can be handled by current WiFi communication protocols and beyond which access points should avoid communicating. As part of the analysis, the processing system may generate a summary of characteristics of the new or changing sources of non-WiFi interference that may be stored in an updated database of known non-WiFi interferers that WiFi access points can use to recognize known sources of non-WiFi interference (e.g., in block 606 of the method 600).

In block 706, the server may perform operations including analyzing the aggregated data to identify potential new or changing sources of non-WiFi interference. This analysis may involve recognizing patterns or characteristics across multiple reports from different WiFi access points, assessing potential impacts on WiFi communication channels, and generating summaries of characteristics and appropriate actions that WiFi access points can take for inclusion in an updated database of known non-WiFi interferers. The updated database may also include various thresholds for new or changed interferers, such as an interference reduction threshold f1, an interference magnitude threshold f2, a performance impact threshold f3, a signal degradation threshold f4, and a maximum interference threshold f5+, to enable WiFi access points to assess the significance of newly identified interference sources.

In block 708, in instances in which a new or changed non-WiFi interference source is identified, the server may perform operations including updating the known interferer database 110 with the characteristics of and appropriate responses to the new or changing non-WiFi interferences. This update may include details such as the fundamental frequency, harmonics, typical duration, and potential mitigation strategies for the newly identified interferer.

In optional block 710, the server may perform operations including transmitting over-the-air updates of the known interferer database 110 to multiple WiFi access points in embodiments in which the known interferer database is stored in the memory of the WiFi access points. These updates may allow WiFi access points to recognize and mitigate the newly identified and/or changed interference sources in the future by accessing the database in local memory, avoiding time delays of accessing a remotely hosted known interferer database.

The method 700 may enable continuous improvement of non-WiFi interference detection and mitigation capabilities across a network of WiFi access points. By leveraging crowdsourced data and performing centralized analysis, the system of WiFi access points and the remote server may adapt to new interference sources and maintain WiFi network performance in diverse environments.

The various embodiments described herein provide several benefits for WiFi networks and their users. By implementing the interference detection and mitigation techniques, WiFi access points may be able to maintain acceptable network performance in the presence of non-WiFi interference sources. The system's ability to actively scan for and characterize interference, compare it against a known interferer database, and execute targeted mitigation actions may result in improved network reliability and user experience. Additionally, the crowdsourced approach to identifying new interference sources provided by some embodiments may allow the system to continuously evolve and adapt to emerging challenges in diverse environments. This may lead to more robust WiFi networks that can effectively handle a wide range of evolving interference scenarios, resulting in better connectivity and performance for end-users across various settings and applications over the long term.

Implementation examples are described in the following paragraphs. While some of the following implementation examples are described in terms of example methods, further example implementations may include: the example methods discussed in the following paragraphs implemented by a computing system including a processing system configured (e.g., with processor-executable instructions) to perform operations of the methods of the following implementation examples; and the example methods discussed in the following paragraphs may be implemented as a non-transitory processor-readable storage medium having stored thereon processor-executable instructions configured to cause a processing system of a computing system to perform the operations of the methods of the following implementation examples.

Example 1: A method of identifying and mitigating non-WiFi source of interference in a WiFi network performed by a WiFi access point, including: detecting, a performance issue in the WiFi network due to non-WiFi interference; performing an active scan to identify characteristics of the detected non-WiFi source of interference; comparing the identified characteristics of the detected non-WiFi source of interference to a database of known non-WiFi interferers stored to determine whether a source of the non-WiFi interference is recognized; determining a mitigation action based on a result of the comparison; and executing the determined mitigation action to address the detected non-WiFi interference.

Example 2: The method of example 1, wherein detecting the performance issue includes monitoring at least one of packet loss, latency, or jitter in the WiFi network.

Example 3: The method of any of examples 1-2, wherein the database of known non-WiFi interferers is stored in a remote server or the cloud.

Example 4: The method of any of examples 1-3, wherein the database of known non-WiFi interferers includes information on fundamental frequencies, harmonics, and durations of known non-WiFi interferers.

Example 5: The method of any of examples 1-4, wherein the database further includes safe interference reduction thresholds for different types of interferers.

Example 6: The method of any of examples 1-5, wherein determining the mitigation action includes selecting between changing operating channels and reducing bandwidth based on characteristics of the identified non-WiFi source of interference.

Example 7: The method of any of examples 1-6, further including logging the identified characteristics of non-WiFi interference that is not recognized in a performance issue database; and transmitting logged identified characteristics of non-WiFi interference that is not recognized in the database of known non-WiFi interferers to a remote server for analysis.

As used in this application, terminology such as “unit,” “component,” “module,” “system,” etc., is intended to encompass a software-implemented or computer-related entity. These entities may involve, among other possibilities, hardware, firmware, a blend of hardware and software, software alone, or software in an operational state. As examples, a component may encompass a running process on a processor, the processing system itself, an object, an executable file, a thread of execution, a program, or a computing device. To illustrate further, both an application operating on a computing device and the computing device itself may be designated as a component. A component might be situated within a single process or thread of execution or could be distributed across multiple processors or cores. In addition, these components may operate based on various non-volatile computer-readable media that store diverse instructions and/or data structures. Communication between components may take place through local or remote processes, function or procedure calls, electronic signaling, data packet exchanges, and memory interactions, among other known methods of network, computer, processor, or process-related communications.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

A number of different types of memories and memory technologies are available or contemplated in the future, any or all of which may be included and used in systems and computing devices that implement the various embodiments.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include random access memory (RAM), read-only memory (ROM), electrically erasable programmable read-only memory (EEPROM), FLASH memory, solid-state drives (SSD), non-volatile memory express (NVMe) drives, or any other medium that may be used to store program code in the form of processor-executable instructions or data structures and that may be accessed by a processor of a computing device. Modern technologies, such as cloud-based storage solutions, including infrastructure-as-a-service (IaaS) platforms, may offer scalable and distributed options for storing and accessing program code.

In addition, the operations of a method or algorithm may reside as one or any combination or set of codes and/or instructions on a non-transitory processor-readable medium and/or computer-readable medium, which may be incorporated into a computer program product. Emerging technologies, including quantum computing storage media and blockchain-based storage solutions, may further enhance data integrity and security. Artificial intelligence (AI) and machine learning (ML)-optimized hardware accelerators, such as graphical processing systems (GPUs) and tensor processing systems (TPUs), may be used to execute complex algorithms.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

We claim:

1. A method of identifying and mitigating non-WiFi source of interference in a WiFi network performed by a WiFi access point, comprising:
detecting a performance issue in the WiFi network due to non-WiFi interference;
performing an active scan to identify characteristics of the detected non-WiFi source of interference;
comparing the identified characteristics of the detected non-WiFi source of interference to a database of known non-WiFi interferers to determine whether a source of the non-WiFi interference is recognized;
determining a mitigation action based on a result of the comparison of the identified characteristics of the detected non-WiFi source of interference to a database of known non-WiFi interferers stored; and
executing the determined mitigation action to address the detected non-WiFi interference.

2. The method of claim 1, wherein detecting the performance issue comprises monitoring at least one of packet loss, latency, or jitter in the WiFi network.

3. The method of claim 1, wherein the database of known non-WiFi interferers is accessed from a remote server.

4. The method of claim 1, wherein the database of known non-WiFi interferers includes information on fundamental frequencies, harmonics, and durations of known non-WiFi interferers.

5. The method of claim 4, wherein the database of known non-WiFi interferers further includes safe interference reduction thresholds for different types of interferers.

6. The method of claim 1, wherein determining the mitigation action comprises selecting between changing operating channels and reducing bandwidth based on characteristics of the identified detected non-WiFi source of interference.

7. The method of claim 1, further comprising:
logging the identified characteristics of non-WiFi interference that is not recognized in a performance issue database; and transmitting logged identified characteristics of non-WiFi interference that is not recognized in the database of known non-WiFi interferers to a remote server for analysis.

8. A WiFi access point, comprising:
a memory;
a WiFi transceiver; and
a processing system coupled to the memory and the WiFi transceiver and configured to perform operations comprising:
detecting a performance issue in a WiFi network due to non-WiFi interference;
performing an active scan by the WiFi transceiver to identify characteristics of a non-WiFi source of interference;
comparing the identified characteristics of the detected non-WiFi source of interference to a database of known non-WiFi interferers to determine whether a source of the non-WiFi interference is recognized;
determining a mitigation action based on a result of the comparison; and
executing the determined mitigation action to address the detected non-WiFi interference.

9. The WiFi access point of claim 8, wherein detecting the performance issue comprises monitoring at least one of packet loss, latency, or jitter in the WiFi network.

10. The WiFi access point of claim 8, wherein the database of known non-WiFi interferers is accessed from a remote server.

11. The WiFi access point of claim 8, wherein the database of known non-WiFi interferers includes information on fundamental frequencies, harmonics, and durations of known non-WiFi interferers.

12. The WiFi access point of claim 11, wherein the database of known non-WiFi interferers further includes safe interference reduction thresholds for different types of interferers.

13. The WiFi access point of claim 8, wherein determining the mitigation action comprises selecting between changing operating channels and reducing bandwidth based on characteristics of the identified non-WiFi source of interference.

14. The WiFi access point of claim 8, wherein the processing system is further configured to perform operations comprising:
logging the identified characteristics of non-WiFi interference that is not recognized in a performance issue database; and
transmitting logged characteristics of non-WiFi interference that is not recognized in the database of known non-WiFi interferers to a remote server for analysis.

15. A non-transitory processor-readable medium having stored thereon processor-executable instructions configured to cause a processor of a WiFi access point device to perform operations comprising:
detecting a performance issue in a WiFi network due to non-WiFi interference;
performing an active scan to identify characteristics of a detected non-WiFi source of interference;
comparing the identified characteristics of the detected non-WiFi source of interference to a database of known non-WiFi interferers device to determine whether a source of the non-WiFi interference is recognized;
determining a mitigation action based on a result of the comparison of the identified characteristics of the detected non-WiFi source of interference to the database of known non-WiFi interferers; and
executing the determined mitigation action to address the detected non-WiFi interference.

16. The non-transitory processor-readable medium of claim 15, wherein the stored-processor executable instructions are configured to cause the processor of a WiFi access point device to perform operations such that detecting the performance issue comprises monitoring at least one of packet loss, latency, or jitter in the WiFi network.

17. The non-transitory processor-readable medium of claim 15, wherein the stored-processor executable instructions are configured to cause the processor of a WiFi access point device to perform operations such that performing the active scan comprises measuring signal strength in frequency channels when WiFi traffic is not detected.

18. The non-transitory processor-readable medium of claim 15, wherein the database of known non-WiFi interferers includes information on fundamental frequencies, harmonics, and durations of known non-WiFi interferers.

19. The non-transitory processor-readable medium of claim 18, wherein the database of known non-WiFi interferers further includes safe interference reduction thresholds for different types of interferers.

20. The non-transitory processor-readable medium of claim 19, wherein the stored-processor executable instructions are configured to cause the processing system of the WiFi access point device to perform operations further comprising:
logging the identified characteristics of non-WiFi interference that is not recognized in a performance issue database; and
transmitting the logged characteristics of non-WiFi interference that is not recognized in the database of known non-WiFi interferers to a remote server for analysis to a remote server for analysis.
